(19) United States
(12) Patent Application Publication
(10) Pub. No.: US 2026/0214229 A1
(43) Pub. Date: Jul. 23, 2026

(54) SELECTIVE NORMALIZATION FOR FEATURE COMPRESSION

(71) Applicant: InterDigital VC Holdings, Inc., Wilmington, DE (US)

(72) Inventors: Hyomin Choi, Sunnyvale, CA (US); Fabien Racape, San Francisco, CA (US); Syed Mateen Ul haq, Coquitlam (CA)

(73) Assignee: InterDigital VC Holdings, Inc., Wilmington, DE (US)

(21) Appl. No.: 19/029,150

(22) Filed: Jan. 17, 2025

(51) Int. Cl. H04N 19/126

(52) U.S. Cl. CPC H04N 19/126

(57) ABSTRACT

Systems, methods, and instrumentalities are disclosed for determining that a reduced feature refinement mode is disabled for reduced feature reconstruction of a feature. Receiving an indication of an inverse normalization type associated with a normalization type used to encode the feature may be performed. Performing inverse normalization on the feature using the inverse normalization type may be performed. Receiving an indication of normalization parameters associated with the normalization type may be performed. Performing inverse normalization on the feature using the inverse normalization type may include performing the inverse normalization on the feature using the inverse normalization type based on the normalization values.

### BACKGROUND

The present application is related to video coding systems that may be used to compress digital video signals, e.g., to reduce the storage and/or transmission bandwidth needed for such signals. Video coding systems may include, for example, block-based, wavelet-based, and/or object-based systems.

### BRIEF SUMMARY

Systems, methods, and instrumentalities are disclosed for a processor configured to determine that a reduced feature refinement mode is disabled for reduced feature reconstruction of a feature. An indication of an inverse normalization type associated with a normalization type used to encode the feature may be received. Inverse normalization on the feature using the inverse normalization type may be performed.

In some examples, an indication of normalization parameters associated with the normalization type may be received. Inverse normalization may be performed on the feature using the inverse normalization type including performing the inverse normalization on the feature using the inverse normalization type based on the normalization values. The feature may be reconstructed. The reconstructed feature may be used as an input to at least a part of a neural network. Inverse normalization may be performed on the feature using the inverse normalization type. The inverse normalization may include, on a condition that the indication of the inverse normalization type comprises a first value, perform inverse normalization on the feature using a first inverse normalization type; and, on a condition that the indication of the inverse normalization type comprises a second value, perform inverse normalization on the feature using a second inverse normalization type.

In some examples, the indication of the inverse normalization type associated with the normalization type used to encode the feature may be indicated in a feature sequence parameter set associated with the feature. The processor may be configured to determine that the reduced feature refinement mode is disabled for the feature may include the processor being configured to receive an indication that the reduced feature refinement mode is disabled for the feature. The inverse normalization type performed using the inverse normalization type may include the processor being configured to perform the inverse normalization type using the inverse normalization type in response to the indication that the reduced feature refinement mode is disabled for the feature. The feature may be a first feature. The processor may be further configured to determine that the reduced feature refinement mode is enabled for a second feature, receive an indication of a refinement parameter, and based on the determination that the reduced feature refinement mode is enabled for the second feature, perform refinement on the second feature based on the refinement parameter.

In some examples, on a condition that the indication of the inverse normalization type includes a first value, parse a minimum value and a maximum value from a feature picture header. On a condition that the indication of the inverse normalization type includes a second value, parse a maximum value from the feature picture header. The indication of the inverse normalization type may include one or more bits. The normalization type may include minimum and/or maximum normalization, absolute maximum normalization, Z-score normalization, median and interquartile range normalization, decimal normalization, logarithmic normalization, or Euclidean normalization.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 shows an example system according to one or more embodiments of the present disclosure.

FIG. 2 shows an example video encoder according to one or more embodiments of the present disclosure.

FIG. 3 shows an example video decoder according to one or more embodiments of the present disclosure.

FIG. 4 illustrates an example video coding for machines pipeline.

FIG. 5 illustrates an example pipeline feature coding for machines.

FIG. 6 illustrates an example regions with convolutional neural network (RCNN) architecture.

FIG. 7 illustrates example shapes tensors to transmit considering the split point after the backbone network of a generalized regions with convolutional neural network architecture.

FIG. 8 illustrates an example shallow network architecture for a feature reduction module interfacing with faster regions with convolutional neural network at feature pyramid network outputs.

FIG. 9A illustrates an example feature conversion feature coding for machines.

FIG. 9B illustrates an example inverse feature conversion in feature coding for machines.

FIG. 10 illustrates an example tiled feature channels into a packed frame.

FIG. 11 illustrates an exemplary inverse quantization and/or normalization process of the Feature coding for machines (FCM) decoder design.

FIG. 12 illustrates an example of applying inverse quantization followed by various normalization methods.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

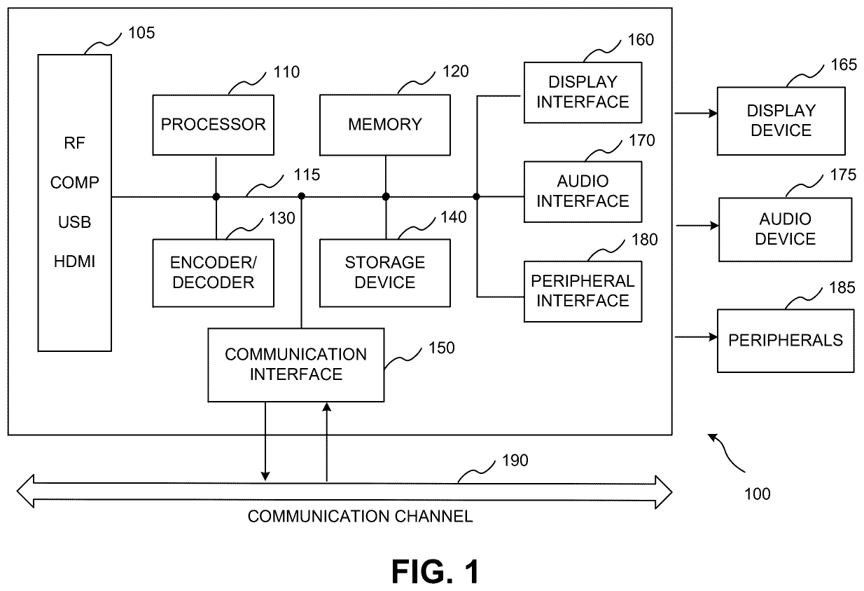

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., 12C bus), wiring, and printed circuit boards.

The system 100 may include at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 may include at least one memory 120, for example, a volatile memory device and/or a non-volatile memory device. The system 100 may include a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 may include an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 may be used to store instructions and/or provide working memory for video encoding and decoding functions. In some embodiments, memory external to the processor 110 and/or the encoder/decoder module 130 (e.g., the memory 120 and/or the storage device 140) may be used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 may include a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., OTT services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

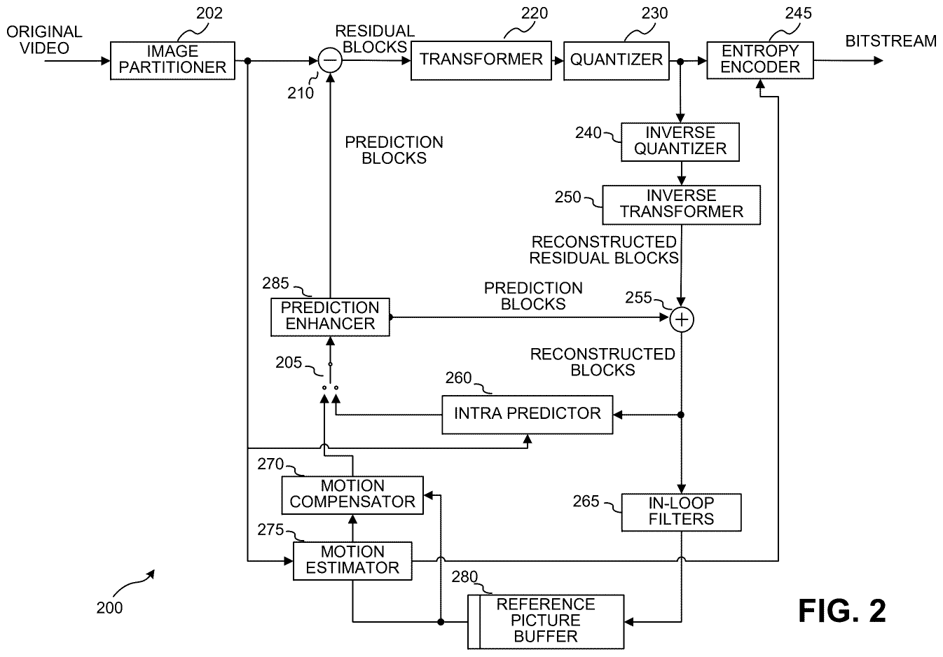

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

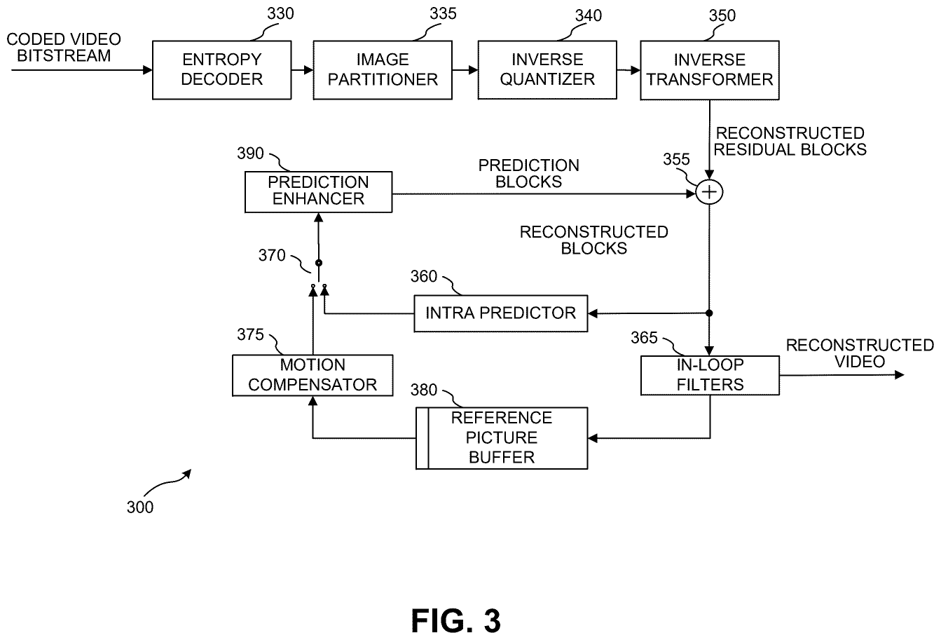

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C, Cb, Cr).

Referring generally to FIG. 2 and the video encoder 200, video data (e.g., one or more video frames) is encoded generally as described below. Prior to encoding, video data may be pre-processed by a precoding processor (not shown). The pre-processing may include, for example, applying a color model transform to the input color components of the input video data (e.g., conversion from RGB 4:4:4 to YUV 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU may include a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (e.g., prediction block, predicted CU) and the input CU. In some embodiments, such determination is made by a subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data.

In addition to coding the original video blocks as described herein, the video encoder 200 reconstructs the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. In the video decoder 300, a coded video bitstream (e.g., generated by the video encoder 200 or another video encoding device or process) is entropy-decoded by an entropy decoder 330 to obtain transform coefficients, motion vectors, and other coding parameters. Based on the coding parameters, an image partitioner 335 divides the picture accordingly. The quantized transform coefficients are de-quantized by an inverse quantizer 340 and inverse transformed by an inverse transformer 350 to decode (e.g., reconstruct) respective residual blocks. Depending on the selected prediction mode, a predicted block can be obtained at 370 from an intra predictor 360 (e.g., intra prediction) or from a motion compensator 375 (e.g., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor (not shown) can process the reconstructed video data. For example, post-decoding processing can include an inverse color model transform (e.g., conversion from YUV 4:2:0 to RGB 4:4:4) or an inverse mapping to reverse the mapping process performed by the pre-encoding processor described with respect to FIG. 2. The post-decoding processor can use metadata derived by the pre-encoding processor and/or signaled in the video bitstream.

Systems, methods, and instrumentalities are disclosed for a processor configured to determine that a reduced feature refinement mode is disabled for reduced feature reconstruction of a feature. An indication of an inverse normalization type associated with a normalization type used to encode the feature may be received. Inverse normalization on the feature using the inverse normalization type may be performed.

In some examples, an indication of normalization parameters associated with the normalization type may be received. Inverse normalization may be performed on the feature using the inverse normalization type including performing the inverse normalization on the feature using the inverse normalization type based on the normalization values. The feature may be reconstructed. The reconstructed feature may be used as an input to at least a part of a neural network. Inverse normalization may be performed on the feature using the inverse normalization type. The inverse normalization may include, on a condition that the indication of the inverse normalization type comprises a first value, perform inverse normalization on the feature using a first inverse normalization type; and, on a condition that the indication of the inverse normalization type comprises a second value, perform inverse normalization on the feature using a second inverse normalization type.

In some examples, the indication of the inverse normalization type associated with the normalization type used to encode the feature may be indicated in a feature sequence parameter set associated with the feature. The processor may be configured to determine that the reduced feature refinement mode is disabled for the feature may include the processor being configured to receive an indication that the reduced feature refinement mode is disabled for the feature. The inverse normalization type performed using the inverse normalization type may include the processor being configured to perform the inverse normalization type using the inverse normalization type in response to the indication that the reduced feature refinement mode is disabled for the feature. The feature may be a first feature. The processor may be further configured to determine that the reduced feature refinement mode is enabled for a second feature, receive an indication of a refinement parameter, and based on the determination that the reduced feature refinement mode is enabled for the second feature, perform refinement on the second feature based on the refinement parameter.

In some examples, on a condition that the indication of the inverse normalization type includes a first value, parse a minimum value and a maximum value from a feature picture header. On a condition that the indication of the inverse normalization type includes a second value, parse a maximum value from the feature picture header. The indication of the inverse normalization type may include one or more bits. The normalization type may include minimum and/or maximum normalization, absolute maximum normalization, Z-score normalization, median and interquartile range normalization, decimal normalization, logarithmic normalization, or Euclidean normalization.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

Split inference and/or collaborative intelligence may be performed. For example, machine vision analytics (e.g., classification, object detection, object tracking, etc.) may be accomplished, for example, with split deep neural networks (DNN). The split DNN may be physically apart from each other but communicating by transmitting intermediate data at a split point.

The amount of video and images consumed by machines may be rapidly increasing, for example, with the rise of machine learning technologies for vision applications (e.g., in domains like intelligent transportations, smart cities, intelligent content management, etc.). Vision tasks may use (e.g., demand) computations (e.g., heavy computations) and may be performed on cloud systems (e.g., rather than the limited devices capturing the source content, which may perform (e.g., requires) the transmitting of the video content). The amount of source data may use performance compression, for example, to fit physical bandwidth and storage capacities (e.g., similar to traditional video transmission pipelines). Machine vision algorithms may not be sensitive to artifacts (e.g., artifacts associated with image and video codecs designed for human consumption), for example, if (e.g., when) applying lossy compression.

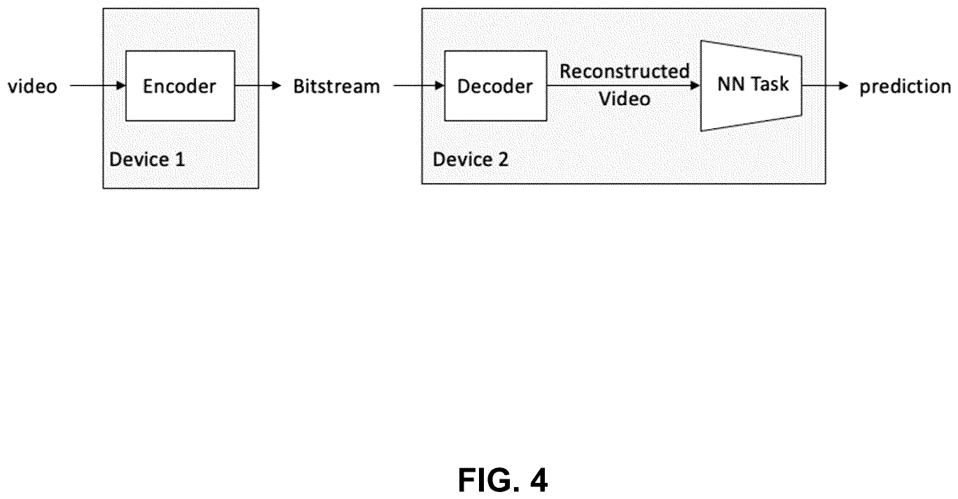

Remote analysis (e.g., efficient remote analysis) may be enabled and/or performed. Remote analysis may include compressing source videos, for example, using actions associated with downstream vision tasks, rather than for human vision (e.g., actions optimized for downstream vision tasks, rather than for human vision). A framework (e.g., shown in FIG. 4) may be used. The framework may include a framework associated with Video Coding for Machines.

FIG. 4 illustrates an example video coding for machines pipeline.

The term video may include one or more of image content or video content. The framework, actions, and descriptions provided herein may apply to both (e.g., image and video) types of content.

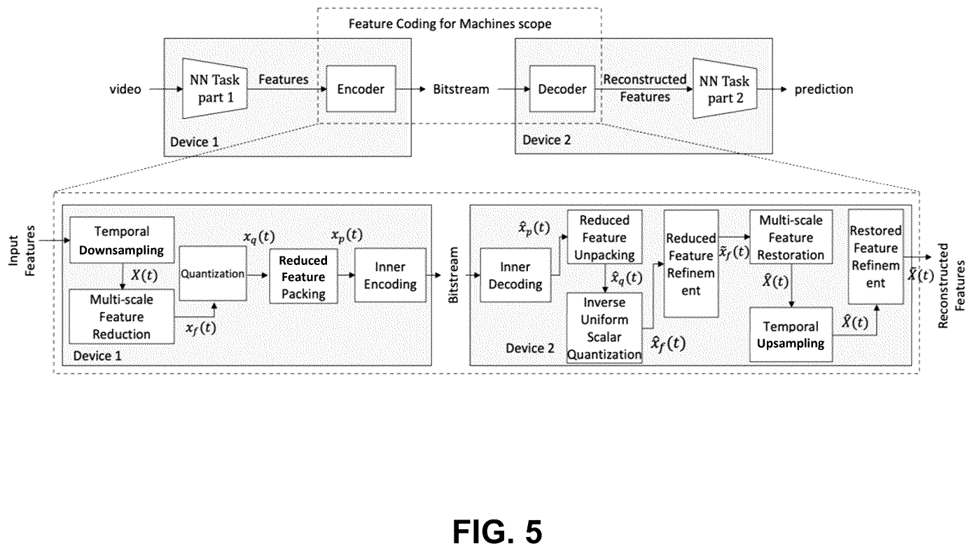

FIG. 5 illustrates an example pipeline feature coding for machines. An example framework may include multiple parts (e.g., two parts) of the split DNN mode (e.g., NN Task Part 1 and NN Task Part 2 as shown in FIG. 5). The parts of the split DNN model (e.g., NN Task Part 1 and NN Task Part 2) may be run on different devices, e.g., NN Task Part 1 on a phone or camera and NN Task Part 2 on the network or cloud. Such splitting of the model may be used to offload (e.g., some of the) computations, for example, if (e.g., when) the device that captures or contains the source content is limited in terms of processing, memory, energy, etc. It can also be useful to transmit such features while protecting the privacy of the original content (e.g., because the original pixels are not directly coded). In this context, at the split point, intermediate data or features need to be transmitted to the remote machine to perform the second part of the model inference.

The device including source video may perform NN Task Part 1 to extract features. These features may be transmitted and/or analyzed remotely by NN Task Part 2. The data volume of the feature tensor(s) may be greater (e.g., much greater) than input data volume. The data volume may be necessary to introduce a codec that efficiently reduces the size of the feature bitstream to enable the transmission over limited bandwidth networks. Conventional standard video codecs may be optimized to natural scene, graphic content, etc. in 2-dimensional input data for human visual system, but may not been designed to compress the computed features in a shape of 3 dimension (3D) over first layers of a DNN for machine vision tasks

FIG. 5 (e.g., at the zoomed-in dashed block) shows example compression modules composing a feature coding for machines coding pipeline. To compress the input features

$$X ( t ) = {\{ {x}_{n} ( t ) \}}_{n = 1}^{N} ,$$

where N is the number of feature tensors with 3-dimension (3D) at time t, from the NN Task Part1, the current version of the FCM encoder may drop some sets (e.g., every other set) of input feature tensors if the temporal downsampling is enabled. As described herein, the “set of tensors” or “picture” may be the plurality of input feature tensors for a given time instant, corresponding to a picture of a video. The non-dropped feature input X(t) at time t may be fed into the multi-scale feature reduction and/or fused into a single tensor x_{f}(t). The multi-scale feature reduction may be a NN-based module that is trained offline to reduce (e.g., significantly reduce) the dimensions of the input tensors. At the feature conversion stage, the reduced feature channels may be quantized with q-bit, tiled and packed onto a 2D frame xₚ(t). The order of the modules in the conversion stages may be swappable. The packed frame with the quantized features xₚ(t) may be encoded into a bitstream.

On the remote server, the FCM inner decoder, e.g., the 2D video codec, may take the bitstream as input and/or reconstruct the tiled frame \hat{x}ₚ (t). The reconstructed tiled frame \hat{x}ₚ (t) may be reshaped into 3D feature tensors \hat{x}_{q}(t) via reduced feature unpacking module. The inverse uniform scalar quantization may be applied to \hat{x}_{q}(t) to get \hat{x}_{f}(t) in the range of 0 to 1.0. Using \hat{x}_{f}(t) as an input, the “reduced feature refinement” module, which may be present (e.g., only present) at the decoder, may scale \hat{x}_{f}(t) to have a standard deviation of 1 and a mean of 0, also known as Z-score normalization, and re-scale back using transmitted statistical parameters of mean and standard deviation for the original x_{f}(t). Scaled \hat{x}_{f}(t) with the transmitted mean and standard deviation may be fed into the Multi-scale Feature Restoration module. The neural network-based restoration module may reconstruct the multiple feature tensors

$$\hat{X} ( t ) = {\{ {\hat{x}}_{n} ( t ) \}}_{n = 1}^{N}$$

that correspond to the interface with the split point(s). If the temporal upsampling module is enabled, the reconstructed \hat{X}(t) may be buffered until the next \hat{X}(t+2) is reconstructed in order to estimate \hat{X}(t+1) with bilinear interpolation. Regardless of the activation of upsampling, the output of the Temporal Upsampling, \hat{X}(t), may be scaled by the scaling module “Restored Feature Refinement”, which may be performed at the decoder (e.g., only), using the transmitted global mean and/or standard deviation of X. The re-scaled feature tensors

$$\tilde{X} ( t ) = {\{ {\tilde{x}}_{n} ( t ) \}}_{n = 1}^{N}$$

may be finally used as input to the NN Task Part 2 to complete the inference of the machine task. As described herein, the variable time t may be omitted if not necessary to discuss different parts of the modules composing the FCM pipeline.

It may be assumed that the pre-trained NN-task-part-1 and NN-task-part-2 may not be trained with an entropy constraint on the intermediate features. In examples, the loss function that drives the training may not include terms related to the potential size of the intermediate data to transmit at the split point. Computer vision algorithms may be trained to maximize the accuracy (e.g., trained to only maximize accuracy), for example, unlike auto-encoders that may introduce information bottleneck to properly train a network with respect to both reconstruction quality and bitrate. Feature maps (e.g., each feature map, or channels) computed through learned computer vision network may contribute to end accuracy (e.g., contribute only to the end accuracy), for example, whatever their coding cost.

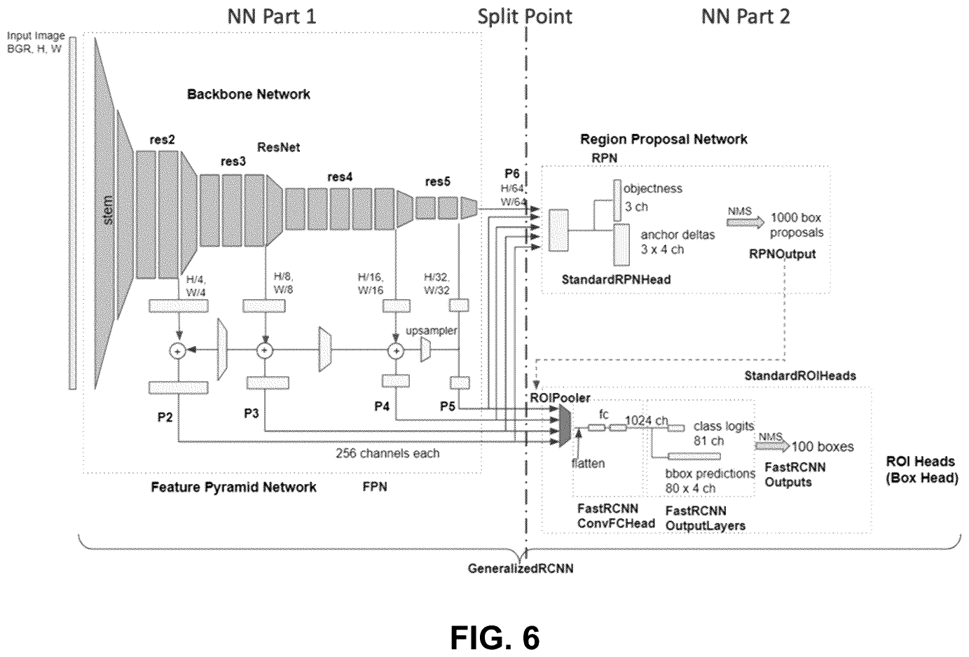

FIG. 6 illustrates an example regions with convolutional neural network (RCNN) architecture. The P layers may include tensors of 256 channels (e.g., with different resolutions). FIG. 6 illustrates an example of a Faster-RCNN architecture. As shown in FIG. 6, the model may include a backbone that may generate feature tensors of different sizes (e.g., P2, P3, P4, P5, P6). The feature tensors (e.g., of different sizes) may be analyzed for tasks, for example, such as object detection and segmentation. In the split-inference context, a split point (e.g., split that separates NN-part-1 and NN-part-2 as shown in FIG. 5) may be considered (e.g., where the encoded and transmitted data corresponds to tensors X={x₁=P2, x₂=P3, x₃=P4, x₄=P5}).

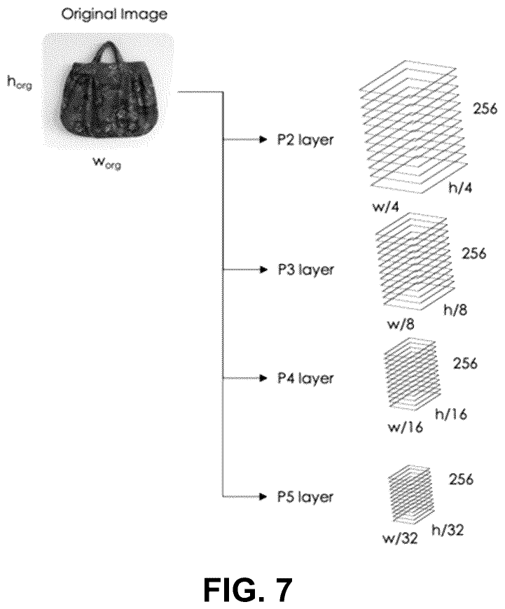

FIG. 7 illustrates example shapes tensors to transmit (e.g., considering the split point after the backbone network of a generalized R-CNN architecture). The tensors may include 256 channels for an input image. The tensors may include different resolutions (e.g., depending on the input resolution). The input resolution to the model may be different from the original image (e.g., size w_{org}×h_{org}), for example, due to rescaling and padding operations.

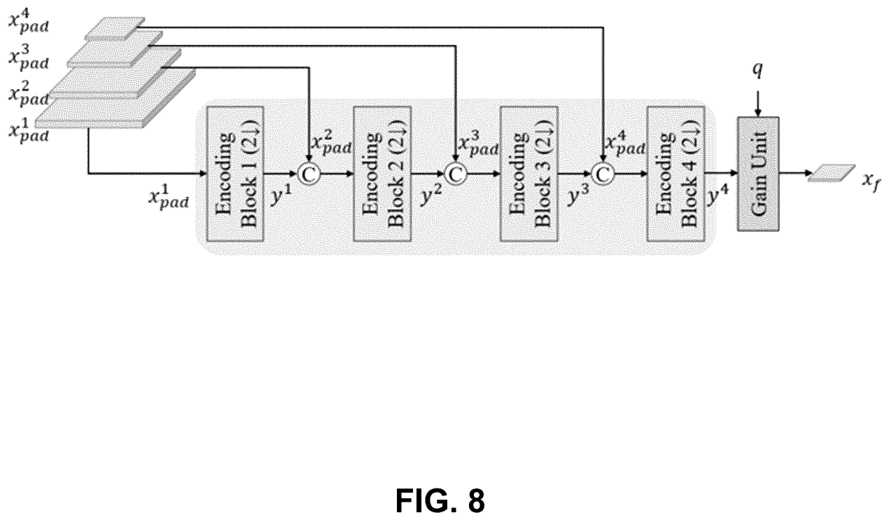

FIG. 8 illustrates an example shallow network architecture for a multi-scale feature fusion module interfacing with faster R-CNN at feature pyramid network outputs P2, P3, P4, and P5. Extracted feature tensors out of the NN Part 1 in Faster R-CNN may be fed into a multi-scale feature fusion model (e.g., as shown in FIG. 8). In examples, P2, P3, P4, P5 may be represented by

$${x}_{pad}^{1} , {x}_{pad}^{2} , {x}_{pad}^{3} , {x}_{pad}^{4} ,$$

respectively. A feature tensor (e.g., each original feature tensor) may be padded (e.g., properly padded) before applying the convolutional layers, for example, because of a spatial shift by nature of the convolution operation.

As shown in FIG. 8, the set of feature tensors may be converted into a single feature tensor (e.g., with 320 channels, y⁴, for example, using convolutional layers with learned weights). A Gain Unit may adjust the scales of the feature tensor y⁴, for example, by multiplying each channel by one of 8 learned vectors. The gain unit may output the reduced feature tensor x_{f} ∈ [symbol] ^{C}^{_{f}}^{×H}^{_{f}}^{×W}^{_{f}} (e.g., where C_{f}=320 and H_{f}×W_{f} may include the spatial resolution of the feature tensor). The index of the vector (e.g., q) as input to the Gain Unit may be heuristically selected or fixed.

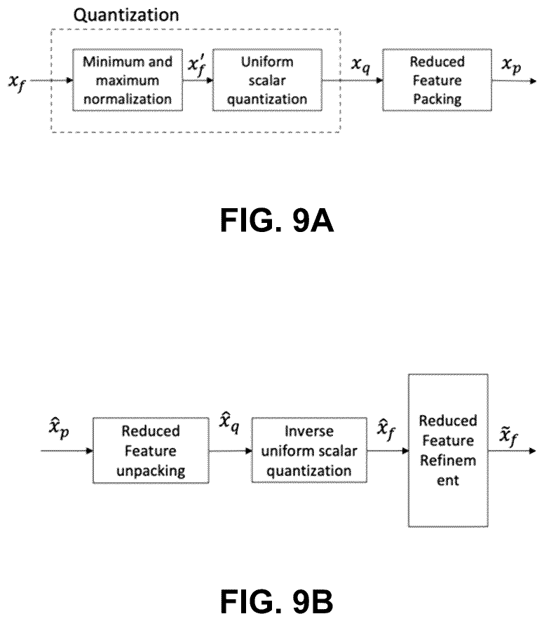

FIG. 9A illustrates an example feature conversion in FCM. FIG. 9B illustrates an inverse feature conversion in FCM. A feature conversion module may reshape (e.g., conduct reshaping) 3D tensors into 2D frames (e.g., followed by quantization), for example, to utilize conventional standard video codecs to encode the reduced feature tensor x_{f} that has 3 dimensions. The reduced feature packing module may conduct the reshaping of the 3D tensor into a 2D frame x_{P}, followed by quantization. FIG. 9A illustrates the current feature conversion including the normalization followed by the uniform scalar quantization and reduced feature packing. For the inverse conversion as shown in FIG. 9B, there are reduced feature unpacking followed by the inverse uniform scalar quantization and reduced feature refinement module. The order between the quantization and fused feature packing may be swappable.

For the reduced feature tensor x_{f} (e.g., each input feature tensor) fused by the multi-scale feature reduction module, the minimum and maximum values of the feature tensors, x_{f,min} and x_{f,max} may be computed and used to normalize the feature values between 0 and 1 according to Eq. 1.

$${x}_{f}^{′} = max ( min ( \frac{{x}_{f} - {x}_{f , m i n}}{{x}_{f , m ax} - {x}_{f , m i n}} , 0 ) , 1 ) \qquad Eq . 1$$

q-bit uniform scalar quantization may be applied to

$${x}_{f}^{′}$$

before packing the feature channels onto a

$${x}_{q} = min ( max ( ⌊ {x}_{f}^{′} \times {2}^{q} ⌋ , 0 ) , {2}^{q} - 1 ) \qquad Eq . 2$$

where └⋅┘ rounds a number down to the nearest integer value.

For the reduced feature packing, the frame resolution Hₚ and Wₚ may be computed such that the shape of the packed frame becomes a wide rectangular, for example, as much as possible by which C_{f} is divided properly in width and height and multiplied by W_{f} and H_{f}, respectively.

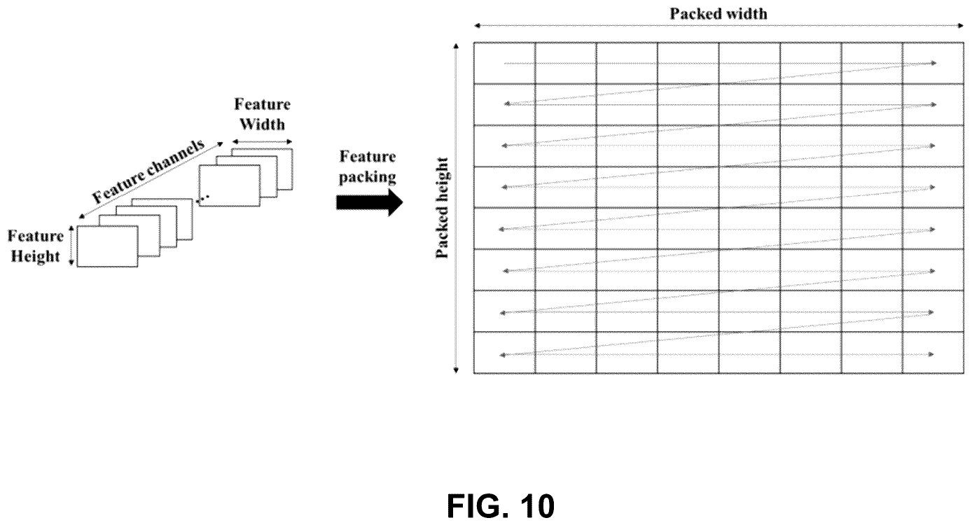

FIG. 10 illustrates an example tiled feature channels into a packed frame. As shown in FIG. 10, the final packed frame may include xₚ∈ [symbol] ^{H}^{ₚ}^{×W}^{ₚ} out of C_{f}.

After the conversion process, the frame xₚ represented in a q-bit integer may be fed into the standard video codec. Other information for the decoding process such as mean and/or standard deviation parameters of the original features for scaling operations, feature tensor sizes, etc., may be coded and/or added to the bitstream. The decoding process may correspond to the inverse scaling and/or packing operations of the encoder in inverse order, using the parsed information from the bitstream. Additional feature refinement operations may be applied at the decoder as shown in FIG. 5 and FIG. 9B.

Since the normalized and quantized features are eventually coded with the standard codec, compression results may vary depending on the normalization computation. Using the normalization computation with Eq.(1) in the encoder side for inter frame coding may achieve less coding gain in terms of bitrate vs. task accuracy than using an absolute maximum value-based normalization method, for example, which may be represented (e.g., mathematically formulated) by

$${x}_{f}^{′} = max ( min ( \frac{\frac{x}{{\vert {x}_{f} \vert}_{m ax 2}} + 1}{2} , 0 ) , 1 ) . \qquad Eq . 3$$

By using Eq (3) as the normalization method instead of Eq (1) in the encoder side, the standard video codec as the inner codec of FCM may benefit from temporally consistent feature values on average for motion estimation and compensation. For intra frame only coding configuration, replacing Eq (1) with Eq (3) may not save bits because the benefit of the change for intra prediction may be limited according to experimental results. The current FCM design may not support selectively choosing the normalization method, also may not have an efficient design of syntax to signal the |x_{f}|ₘₐₓ values to the decoder (e.g., if needed).

A normalization operation may be selectively chosen and/or performed at the encoder and/or may signal the type of normalization to the decoder so that it may perform the inverse operation if the reduced feature restoration refinement method is disabled.

The current syntax design of FCM may enable activation of a reduced feature refinement process at the decoder depending on a flag “reduced_feat_refine_enableiflag” parsed from the Feature Sequence Parameter Set (FSPS), as shown in Table 1.

TABLE 1
FCM syntax table for feature sequence parameter set (FSPS).

| | Descriptor |
|---|---|
| feat_seq_parameter_set_rbsp( ) { | |
| fsps_feat_seq_parameter_set_id | |
| num_ori_feat_layers | |
| for (i = 0; i < num_ori_feature_layers; i++) { | |
| ori_feat_wid[i] | |
| ori_feat_hei[i] | |
| num_ori_feat_chan[i] | |
| } | |
| ... | |
| temporal_upsampling_enable_flag | u(1) |
| restored_feat_refine_enable_flag | u(1) |
| reduced_feat_refine_enable_flag | u(1) |
| ... | |
| rbsp_trailing_bits( ) | |
| } | |

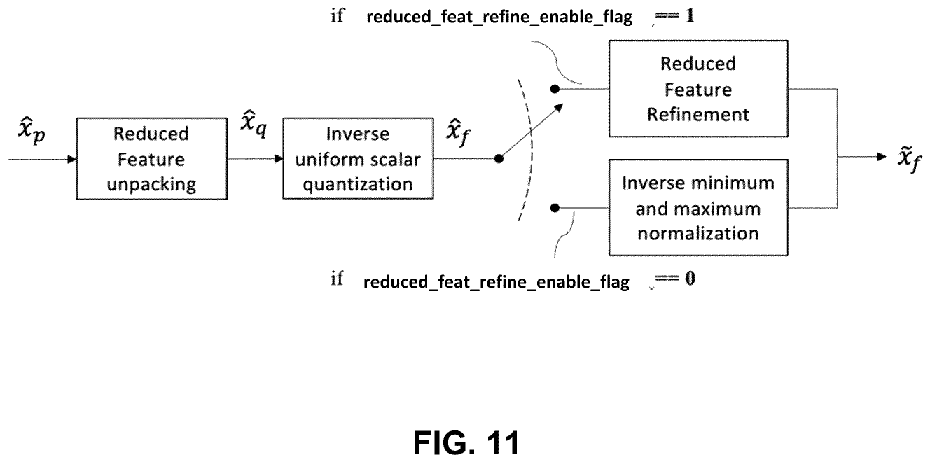

FIG. 11 illustrates an inverse quantization and/or normalization process of a FCM decoder design. The FCM encoder design may conduct a minimum and/or maximum normalization process as shown in FIG. 9A regardless of “reduced_feat_refine_enable_flag”. If the “reduced_feat_refine_enable_flag” is True, there may be no inverse minimum and/or maximum normalization at the decoder as shown in FIG. 9B. In this case, there may be no signaling of the minimum and/or maximum values. The refinement parameters may be indicated in a Feature Picture Parameter Set. The inverse minimum and/or maximum normalization may be executed if the “reduced_feat_refine_eanble_flag” is False from the FSPS in use, as shown in FIG. 11.

The minimum and/or maximum values may be signaled in the Feature Picture Header as shown in Table 2.

TABLE 2
FCM syntax table for feature picture header (FPH) with temporary
solution for the minimum and maximum signaling

| | Descriptor |
|---|---|
| feature_pic_header _rbsp( ) { | |
| fph_feature_pic_parameter_set_id | ue(v) |
| fph_picture_order_count_value | i(32) |
| if (!reduced_feat_refine_enable_flag) { | |
| fph_updated_maximum_feature_value | float32 |
| fph_updated_minimum_feature_value | float32 |
| } | |
| if( fsps_temporal_upsampling_enable_flag ) { | |
| fph_inactive_upsampling_flag | u(1) |
| } | |
| rbsp_trailing_bits( ) | |
| } | |

The minimum and/or maximum normalization in Eq (1) may be replaced with the absolute maximum-based normalization I Eq (3) in the encoder side. The decoding process may not be (e.g., clearly) defined if the “reduced_feat_refine_enable_flag” is set to 0. With the above temporary solution, the current design of FCM may signal the maximum (e.g., absolute maximum value) using the original syntax coding for the minimum and/or maximum values in 32 bits although only one value may be needed instead of two.

To address and/or support the inverse normalization methods if the “reduced_feat_refine_enable_flag” is 0, a new signaling method in the Feature Picture Header may be used.

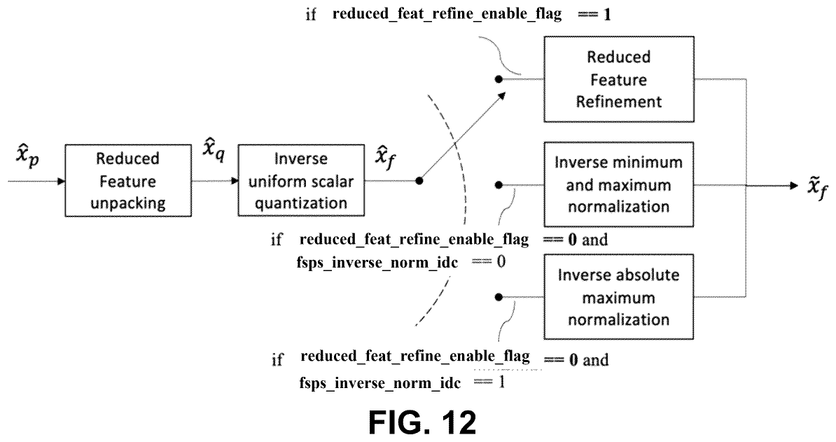

If the refinement of reduced feature tensors is disabled, the FCM may signal minimum and/or maximum values for each picture to carry out an inverse normalization process that takes place after the inverse uniform scalar quantization. If another normalization method is used at the encoder side, but the refinement of the reduced feature refinement is disabled at the decoder, the current syntax may not support it. For example, if the absolute maximum value-based normalization Eq (3) is used and the reduced feature refinement is disabled, only the absolute maximum value needs to be signaled. FIG. 12 shows the proposed inverse quantization followed by multiple choices of normalization methods. If the “reduced_feat_refine_enable_flag” is equal to 1, the output of the inverse uniform scalar quantization should be fed into the refinement module independently of the value of “fsps_inverse_norm_idc”. If the “reduced_feat_refine_enable_flag” is equal to 0, then depending on “fsps_inverse_norm_idc” the inverse normalization method may be determined. For example, if “fsps_inverse_norm_idc” is equal to 0, the inverse minimum and maximum normalization with Eq(1) may be carried out. If “fsps_inverse_norm_idc” is equal to 1, then the absolute maximum value-based normalization with Eq(3) may be conducted. In practice, other normalization methods could be added, which may be later addressed using extra bits reserved for “fsps_inverse_norm_idc”.

FIG. 12 illustrates an inverse quantization followed by various normalization methods. To signal the “fsps_inverse_norm_idc”, Table 3 illustrates the updated syntax table for Feature Sequence Parameter Set. Specifically, if “reduced_feat_refine_enable_flag” is equal to 0, “fsps_inverse_norm_idc” may be signaled as a flag when supporting only two different normalization methods. In examples, more bits may be utilized to signal “fsps_inverse_norm_idc” with reserved syntax to support any other normalization methods, including custom normalization methods.

TABLE 3
Syntax table for Feature Sequence Parameter Set with signaling

| | Descriptor |
|---|---|
| feat_seq_parameter_set _rbsp ( ) { | |
| fsps_feat_seq_parameter_set_id | |
| num_ori_feat_layers | |
| for (i = 0; i < num_ori_feature_layers; i++) { | |
| ori_feat_wid[i] | |
| ori_feat_hei[i] | |
| num_ori_feat_chan[i] | |
| } | |
| ... | |
| temporal_upsampling_enable_flag | u(1) |
| restored_feat_refine_enable_flag | u(1) |
| reduced_feat_refine_enable_flag | u(1) |
| if (!reduced_feat_refine_enable_flag) | |
| fsps_inverse_norm_idc | u(1) |
| ... | |
| rbsp_trailing_bits( ) | |
| } | |

In examples, fsps_inverse_norm_idc may specify the inverse normalization mode, for example, if the reduced_feat_refine_enable_flag is set to 0. If fsp_snverse_norm_idc is equal to 0, for example, the minimum and maximum values may be signaled and/or parsed from a feature picture header to conduct the normalization method. If fsps_inverse_norm_idc is equal to 1, for example, a value (e.g., only the maximum value) may be signaled and/or parsed from the feature picture header for the normalization method. In examples, two (e.g., only two) normalization methods may be available. Table 4 illustrates the syntax table for the Feature Picture Header (FPH) with the minimum value signaled conditioned on “fsps_inverse_norm_idc”.

TABLE 4
Syntax table for feature picture header (FPH)

| | Descriptor |
|---|---|
| feature_pic_header_rbsp( ) { | |
| fph_feature_pic_parameter_set_id | ue(v) |
| fph_picture_order_count_value | i(32) |
| if (!reduced_feat_refine_enable_flag) { | |
| fph_sequence_wise_maximum_value | float32 |
| if (fsps_inverse_norm_idc == 0) | |
| fph_sequence_wise_minimum_value | float32 |
| } | |
| if( fsps_temporal_upsampling_enable_flag ) { | |
| fph_inactive_upsampling_flag | u(1) |
| } | |
| rbsp_trailing_bits( ) | |
| } | |

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:
i. Encoding, into coded video data, syntax elements that can enable the decoder to decode the coded video data, according to any of the embodiments described herein.
ii. Video data (e.g., a bitstream) that may include one or more of the described syntax elements, or variations thereof, whether transmitted, stored, or otherwise made available.
iii. Creating, transmitting, receiving, and/or decoding of the bitstream.
iv. An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data an order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, that can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
i. session description protocol (SDP), for example as described in RFCs and/or used in conjunction with real-time transport protocol (RTP) transmission.
ii. hypertext transfer protocol (HTTP) live Streaming (HLS) manifest transmitted over HTTP.
iii. dynamic adaptive streaming over HTTP (DASH) media presentation description (MPD) descriptors, for example as used in DASH and transmitted over HTTP.
iv. RTP header extensions, for example as used during RTP streaming.
v. International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter may be used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), bit savings is thus realized in some embodiments. In some embodiments, one or more syntax elements or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment). Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A device for video decoding, the device comprising:
a processor configured to:
determine that a reduced feature refinement mode is disabled for reduced feature reconstruction of a feature;
receive an indication of an inverse normalization type associated with a normalization type used to encode the feature; and
perform inverse normalization on the feature using the inverse normalization type.

2. The device of claim 1, wherein the processor is further configured to receive an indication of normalization parameters associated with the normalization type, and the processor being configured to perform inverse normalization on the feature using the inverse normalization type comprises the processor being configured to perform the inverse normalization on the feature using the inverse normalization type based on the normalization parameters.

3. The device of claim 1, wherein the processor is further configured to:
reconstruct the feature; and
use the reconstructed feature as an input to at least a part of a neural network.

4. The device of claim 1, wherein the processor being configured to perform inverse normalization on the feature using the inverse normalization type comprises the processor being configured to:
on a condition that the indication of the inverse normalization type comprises a first value, perform inverse normalization on the feature using a first inverse normalization type; and
on a condition that the indication of the inverse normalization type comprises a second value, perform inverse normalization on the feature using a second inverse normalization type.

5. The device of claim 1, wherein the indication of the inverse normalization type associated with the normalization type used to encode the feature is indicated in a feature sequence parameter set associated with the feature.

6. The device of claim 1, wherein the processor being configured to determine that the reduced feature refinement mode is disabled for the feature comprises the processor being configured to receive an indication that the reduced feature refinement mode is disabled for the feature, and wherein the processor being configured to perform inverse normalization on the feature using the inverse normalization type comprises the processor being configured to perform inverse normalization on the feature using the inverse normalization type in response to the indication that the reduced feature refinement mode is disabled for the feature.

7. The device of claim 1, wherein the feature is a first feature, and the processor is further configured to:
determine that the reduced feature refinement mode is enabled for a second feature;
receive an indication of a refinement parameter; and
based on the determination that the reduced feature refinement mode is enabled for the second feature, perform refinement on the second feature based on the refinement parameter.

8. The device of claim 1, wherein the processor is further configured to:
on a condition that the indication of the inverse normalization type comprises a first value, parse a minimum value and a maximum value from a feature picture header; and
on a condition that the indication of the inverse normalization type comprises a second value, parse a maximum value from the feature picture header.

9. The device of claim 1, wherein the indication of the inverse normalization type comprises one or more bits.

10. The device of claim 1, wherein the normalization type comprises:
minimum and maximum normalization;
absolute maximum normalization;
Z-score normalization;
median and interquartile range normalization;
decimal normalization;
logarithmic normalization; or
Euclidean normalization.

11. A device for video encoding, the device comprising:
a processor configured to:
determine a normalization type with which to encode a feature;
perform normalization on the feature using the normalization type; and
include, in video data, an indication of an inverse normalization type associated with the normalization type used to encode the feature.

12. The device of claim 11, wherein the processor is further configured to include, in the video data, an indication of inverse normalization values associated with the inverse normalization type.

13. The device of claim 11, wherein the processor is further configured to:
receive, from an output of at least a part of a neural network, intermediate data associated with the feature; and
include, in the video data, an indication of the intermediate data.

14. The device of claim 11, wherein the processor being configured to include, in the video data, the indication of the normalization type used to encode the feature comprises the processor being configured to:
on a condition that a first normalization type was used to encode the feature, include a first value in the video data; and
on a condition that a second normalization type was used to encode the feature, include a second value in the video data.

15. The device of claim 11, wherein the indication of the inverse normalization type associated with the normalization type used to encode the feature is indicated in a feature sequence parameter set associated with the feature.

16. The device of claim 11, wherein the processor is further configured to:
determine that a reduced feature refinement mode is disabled for the feature; and
include, in the video data, an indication that the reduced feature refinement mode is disabled for the feature.

17. The device of claim 11, wherein the feature is a first feature, and the processor is further configured to:
determine that a reduced feature refinement mode is enabled for a second feature;
determine a refinement parameter associated with the second feature; and
include, in the video data, an indication of the refinement parameter.

18. The device of claim 11, wherein the processor is further configured to:
on a condition that the indication of the inverse normalization type comprises a first value, include a minimum value and a maximum value in a feature picture header; and
on a condition that the indication of the inverse normalization type comprises a second value, include a maximum value in the feature picture header.

19. The device of claim 11, wherein the indication of the inverse normalization type comprises one or more bits.

20. The device of claim 11, wherein the normalization type comprises:
minimum and maximum normalization;
absolute maximum normalization;
Z-score normalization;
median and interquartile range normalization;
decimal normalization;
logarithmic normalization; or
Euclidean normalization.
